(19) United States
(12) Patent Application Publication
(10) Pub. No.: US 2025/0100162 A1
(43) Pub. Date: Mar. 27, 2025

(54) GRIPPING DEVICE, GRIPPING SYSTEM, AND CONTROL METHOD BY GRIPPING DEVICE

(71) Applicant: MINEBEA MITSUMI Inc., Nagano (JP)

(72) Inventor: Yujin ISHI, Nagano (JP)

(21) Appl. No.: 18/730,917

(22) PCT Filed: Jan. 23, 2023
(86) PCT No.: PCT/JP2023/001872

§ 371 Date: Jul. 22, 2024

(30) Foreign Application Priority Data
Jan. 27, 2022 (JP) 2022-011148

(51) Int. Cl. B25J 13/08

(52) U.S. Cl. CPC B25J 13/082

(57) ABSTRACT

A gripping device includes a motor configured to rotate according to an operation value; a grasper including a first finger and a second finger, the grasper being configured to change a distance between the first finger and the second finger by using the motor, and to grip an object with the first finger and the second finger; a force detector configured to detect a gripping force by which the object is gripped with the first finger and the second finger, upon occurrence of a condition in which the object is gripped with the first finger and the second finger; and a controller configured to output the operation value such that a force detection value of the gripping force detected by the force detector matches a force command value. The controller is configured to detect a deviation of the object from a predetermined reference position based on a time period from a start of a gripping operation from a timing at which any one of the first finger and the second finger contacts the object.

### TECHNICAL FIELD

The present disclosure relates to a gripping device, a gripping system, and a control method by the gripping device.

### BACKGROUND

When product-manufacturing lines are automated using a robot or the like, gripping devices called manipulators or grippers are used to grip objects to be gripped, such as mechanical components or electrical components.

Patent Document 1 discloses a robot device capable of reliably gripping an object when position information of the object includes an error.

### RELATED-ART DOCUMENTS

### Patent Documents

Patent Document 1: Japanese Unexamined Patent Application Publication No. 2012-011531

### SUMMARY

### Problem to be Solved by the Invention

In gripping devices, a grip target is gripped, assuming, for example, that a work (grip target) is disposed at a predetermined position (reference position). For example, in the gripping devices, a position of the work (grip target) where a center position of the work (grip target) matches a center position of a gripping position at which the gripping device grips the work (grip target) is assumed to be used as the reference position. In this arrangement, the work is gripped by the gripping devices, assuming that the work (grip target) is disposed at the reference position.

When a gripping device is attached to a tip portion of a multi-joint robot, a scalar robot, or the like in operation, it is necessary to perform teaching in which for example, the center position of the work (grip target) and the center position of the gripping position at which the gripping device performs gripping are adjusted such that the grip target is positioned at the reference position of the gripping device. Typically in the teaching, it is necessary to adjust any center position in a unit of 0.1 millimeters, and work effort is increased. When the teaching is performed in a misaligned state, an unintended torque load is applied to the work (grip target) or the gripping device, which may result in damage.

The present disclosure provides a gripping device capable of detecting a deviation of a grip target from a predetermined reference position.

### Means for Solving the Problem

In one aspect of the present disclosure, a gripping device includes a motor configured to rotate according to an operation value; a grasper including a first finger and a second finger, the grasper being configured to change a distance between the first finger and the second finger by using the motor and to grip an object with the first finger and the second finger; a force detector configured to detect a gripping force by which the object is gripped with the first finger and the second finger, upon occurrence of a condition in which the object is gripped with the first finger and the second finger; and a controller configured to output the operation value such that a force detection value of the gripping force detected by the force detector matches a force command value. The controller is configured to detect a deviation of the object from a predetermined reference position based on a time period from a start of a gripping operation from a timing at which any one of the first finger and the second finger contacts the object.

### Effects of the Invention

In a gripping device in the present disclosure, a deviation of a grip target from a predetermined reference position can be detected.

### BRIEF DESCRIPTION OF THE DRAWINGS

FIG. 1 is a diagram showing a configuration example of a gripping device according to the present embodiment.

FIG. 2 is a diagram for describing a functional configuration of the gripping device according to the present embodiment.

FIG. 3 is a diagram for describing a functional configuration of an arithmetic processing unit included in a controller of the gripping device according to the present embodiment.

FIG. 4 is a diagram for describing a functional configuration of an operational value calculator of the arithmetic processing unit included in the controller of the gripping device according to the present embodiment.

FIG. 5 is a diagram for describing a functional configuration of an admittance processing unit of the arithmetic processing unit included in the controller of the gripping device according to the present embodiment.

FIG. 6 is a diagram for describing a functional configuration of a position-and-speed calculator of the arithmetic processing unit included in the controller of the gripping device according to the present embodiment.

FIG. 7 is a diagram for describing a functional configuration of a current calculator of the arithmetic processing unit included in the controller of the gripping device according to the present embodiment.

FIG. 8 is a flowchart for describing a process by the arithmetic processing unit included in the controller of the gripping device according to the present embodiment.

FIG. 9 is a diagram for describing the operation of the gripping device according to the present embodiment.

FIG. 10 is a diagram for describing the operation of the gripping device according to the present embodiment.

FIG. 11 is a diagram for describing the operation of the gripping device in a comparative example.

FIG. 12 is a diagram showing a configuration example of a gripping system using the gripping device according to the present embodiment.

FIG. 13 is a diagram for describing a functional configuration of the gripping system using the gripping device according to the present embodiment.

FIG. 14 is a flowchart for describing a process by the gripping system using the gripping device according to the present embodiment.

FIG. 15 is a flowchart for describing the process by the gripping system using the gripping device in a modification to the present embodiment.

### MODE FOR CARRYING OUT THE INVENTION

### <<Gripping Device>>

### <Gripping Device 1>

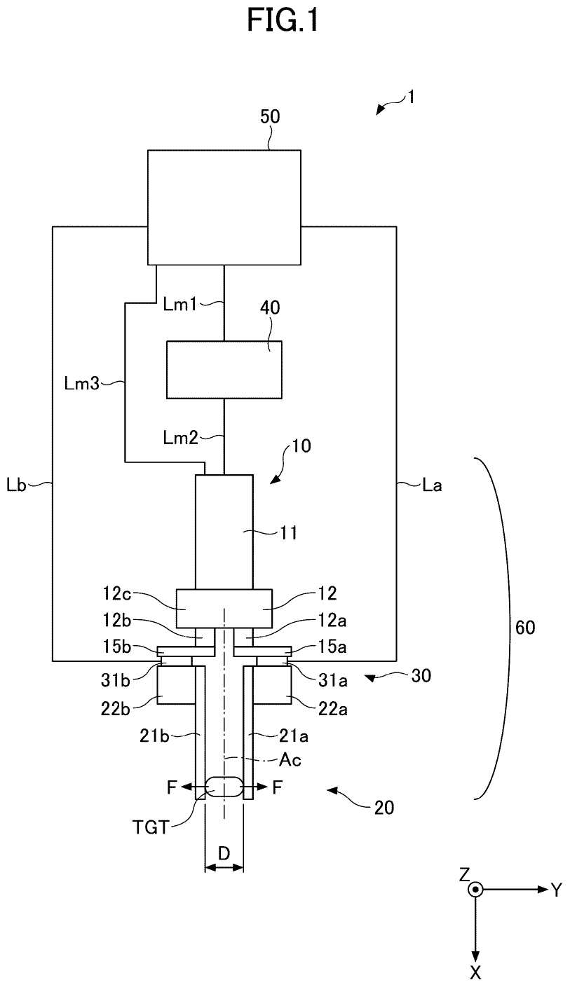

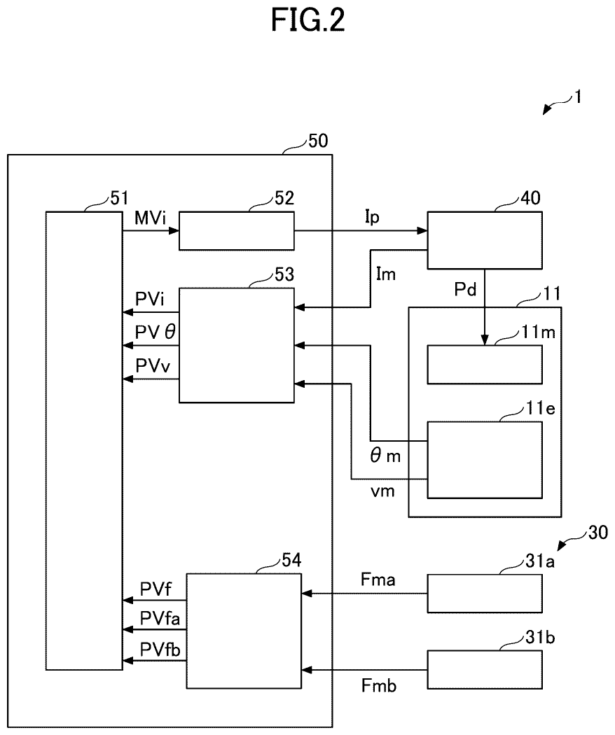

Hereinafter, a gripping device according to the present embodiment will be described in detail with reference to the drawings. FIG. 1 is a diagram showing a configuration example of a gripping device 1 according to the present embodiment. FIG. 2 is a diagram for describing a functional configuration of the gripping device 1 according to the present embodiment.

Note that in FIG. 1, a virtual three-dimensional coordinate system (XYZ-orthogonal coordinate system), defined by an X-axis, a Y-axis, and a Z-axis (XYZ axes) that are mutually perpendicular, is set for ease of explanation. For example, for a coordinate axis perpendicular to a paper surface of the drawing, when a black circle is illustrated in a circle expressing the coordinate axis, the black circle shows that a front side of the paper surface is in a positive region of the coordinate axis. However, the coordinate system is determined for the purpose of explanation, and a posture of the gripping device 1 is not intended to be limiting.

In FIG. 1, an X-axis direction refers to a direction in which a first finger 21a and a second finger 21b extend. In addition, a Y-axis direction refers to a direction in which each of the first finger 21a and the second finger 21b moves. The Z-axis corresponds to a direction perpendicular to the X-axis and the Y-axis.

The gripping device 1 is attached to, for example, an arm tip of a robot, and grips a grip target TGT. Specifically, the gripping device 1 grips the grip target TGT between the first finger 21a and the second finger 21b. The gripping device 1 includes a drive unit 10, a grasper 20, a force detector 30, a motor drive unit 40, and a controller 50. The drive unit 10, the grasper 20, and the force detector 30 may be collectively referred to as a mechanism unit 60. Each component of the gripping device 1 will be described in detail as follows.

The controller 50 and the motor drive unit 40 are coupled to each other by a wire Lm1. The motor drive unit 40 and the drive unit 10, more specifically the motor drive unit 40 and a power unit 11 (motor 11m) of the drive unit 10, are coupled by a wire Lm2. Further, the controller 50 and the drive unit 10, more specifically the controller 50 and the power unit 11 (encoder 11e) of the drive unit 10 are coupled by a wire Lm3.

### [Drive Unit 10]

The drive unit 10 changes a distance between the first finger 21a and the second finger 21b. Specifically, the drive unit 10 moves the first finger 21a and the second finger 21b in opposite directions of Y-axis directions.

The drive unit 10 includes the power unit 11 and a motion converter 12. The power unit 11 and the motion converter 12 will be described in detail as follows.

### (Power Unit 11)

The power unit 11 rotates a rotary shaft based on power that is supplied from the motor drive unit 40 via the wire Lm2. The power unit 11 converts the power to rotational motion, and transmits the rotational motion to the motion converter 12.

The power unit 11 includes the motor 11m and the encoder 11e. The motor 11m includes, for example, an alternating current (AC) motor, a stepping motor, or the like. The motor 11m rotates the rotary shaft based on the power (supplied power Pd) supplied from the motor drive unit 40. As described below, the supplied power Pd is determined based on a current control value MVi. In this arrangement, the motor 11m rotates based on the current control value MVi. The motor 11m has any known configuration of the motor that includes the rotary shaft, a stator, a rotor, and the like.

The encoder 11e detects the position and the rotation speed of the rotary shaft of the motor 11m. The encoder 11e outputs a detection result to the controller 50 via the wire Lm3.

### (Motion Converter 12)

The motion converter 12 converts the rotational motion that is transmitted from the motor 11m, to the linear motion in the Y-axis direction. The motion converter 12 is constituted, for example, by mechanism components such as a gear, a worm gear, and a cam. The motion converter 12 includes a moving unit 12a and a moving unit 12b each of which protrudes from a housing 12c. Each of the moving unit 12a and the moving unit 12b is movable with respect to the housing 12c. The motion converter 12 converts the rotational motion transmitted from the motor 11m to the linear motion that enables the moving unit 12a and the moving unit 12b to move in the Y-axis direction with respect to the housing 12c.

When the motor 11m rotates in one direction, for example, the moving unit 12a moves in a positive Y-direction of Y-axis directions. When the motor 11m rotates in an opposite direction, for example, the moving unit 12a moves in a negative Y-direction of the Y-axis directions. When the motor 11m rotates in one direction, for example, the moving unit 12b moves in the negative Y-direction of the Y-axis directions. When the motor 11m rotates in an opposite direction, for example, the moving unit 12b moves in the positive Y-direction of the Y-axis directions.

That is, when the motor 11m rotates in one direction, the moving unit 12a and the moving unit 12b move in opposite directions of the Y-axis direction, specifically in directions that are away from each other in the Y-axis directions. With this arrangement, when the motor 11m rotates in one direction, a greater distance between the moving unit 12a and the moving unit 12b is obtained. When the motor 11m rotates in the opposite direction, the moving unit 12a and the moving unit 12b move in opposite directions of the Y-axis directions, specifically in directions in which the moving unit 12a and the moving unit 12b are closer to each other in the Y-axis directions. Thus, when the motor 11m rotates in the opposite direction, a shorter distance between the moving unit 12a and the moving unit 12b is obtained.

As described above, the drive unit 10 can change the distance between the moving unit 12a and the moving unit 12b, in accordance with the rotation of the motor 11m.

### [Grasper 20]

The grasper 20 grips the grip target TGT between the first finger 21a and the second finger 21b, when the drive unit 10 changes a distance between the moving unit 12a and the moving unit 12b.

The grasper 20 includes the first finger 21a and a first holder 22a for holding the first finger 21a, toward a positive Y-side of the Y-axis direction with respect to a center position Ac. The first finger 21a is fixed to the first holder 22a. The first holder 22a is fixed to the moving unit 12a via a first force sensor 31a described below. The gripping device 1 includes a fixing unit 15a for fixing the first force sensor 31a to the moving unit 12a. The center position Ac is at the center of a position that is a gripping position at which the gripping device 1 allows for gripping. The gripping position is at the center of the position in a grip direction (Y-axis direction) in which the gripping is performed using the first finger 21a and the second finger 21b.

The grasper 20 includes a second finger 21b and a second holder 22b for holding the second finger 21b, toward a negative Y-side of the Y-axis direction with respect to the center position Ac. The second finger 21b is fixed to the second holder 22b. The second holder 22b is fixed to the moving unit 12b via a second force sensor 31b described below. The gripping device 1 includes a fixing unit 15b for fixing the second force sensor 31b to the moving unit 12b.

When the moving unit 12a moves in the Y-axis direction, the first finger 21a moves in the Y-axis direction together with the moving unit 12a. Similarly, when the moving unit 12b moves in the Y-axis direction, the second finger 21b moves in the Y-axis direction together with the moving unit 12b. In this arrangement, when the distance between the moving unit 12a and the moving unit 12b varies, a distance D between the first finger 21a and the second finger 21b varies accordingly. By decreasing the distance D between the first finger 21a and the second finger 21b, the grasper 20 grips the grip target TGT, with the first finger 21a and the second finger 21b.

A case where the grip target TGT is gripped by the grasper 20 is limited to a case where the grip target TGT is gripped between the first finger 21a and the second finger 21b. For example, a grip target having a ring shape may be gripped by moving fingers in a direction from the inside toward the outside of a ring in which the fingers are inserted.

[Force Detector 30] The force detector 30 detects a force (gripping force) that is applied between the first finger 21a and the second finger 21b, when the grasper 20 grips the grip target TGT. The force detector 30 includes the first force sensor 31a and the second force sensor 31b. Each of the first force sensor 31a and the second force sensor 31b is, for example, a six-axis force sensor.

The first force sensor 31a is coupled to the controller 50 via the wire La. The second force sensor 31b is coupled to the controller 50 via the wire Lb. The force detector 30 uses a detection result on a force in the Y-axis direction that is output from the six-axis force sensor.

The first force sensor 31a is fixed to the first holder 22a that holds the first finger 21a. The first force sensor 31a is fixed to the moving unit 12a via the fixing unit 15a. The first force sensor 31a detects a pushing force that the grip target TGT applies on the first finger 21a, when the grasper 20 grips the grip target TGT.

The second force sensor 31b is fixed to the second holder 22b that holds the second finger 21b. The second force sensor 31b is fixed to the moving unit 12b via a fixing unit 15b. The second force sensor 31b detects a pushing force that the grip target TGT applies on the second finger 21b, when the grasper 20 grips the grip target TGT.

The gripping device 1 according to the present embodiment includes the force detector 30 between the drive unit 10 and the grasper 20, but a location where the force detector 30 is provided is not limited to the location between the drive unit 10 and the grasper 20. For example, the gripping device 1 may include the first force sensor 31a and the second force sensor 31b at tips of the first finger 21a and the second finger 21b, respectively.

A type of the force sensor is not limited as long as the force sensor can detect the gripping force that is applied between the first finger 21a and the second finger 21b. As the force sensor, for example, a micro electro mechanical systems (MEMS) sensor capable of detecting a force may be used, or a piezoelectric element or a strain gauge may be used. For example, when the MEMS sensor or the strain gauge is used, a flexure element that generates strain by an external force may be used to detect the force, or a portion of the grasper 20 may be used as the flexure element.

The force detector 30 according to the present embodiment includes the first force sensor 31a and the second force sensor 31b, but may include only one of the first force sensor 31a and the second force sensor 31b. That is, the force sensor may be provided in only one of the first finger 21a and the second finger 21b.

### [Motor Drive Unit 40]

The motor drive unit 40 supplies power (supplied power Pd) to the drive unit 10, more specifically to the motor 11m, based on an operation command (current control signal Ip) from the controller 50. The drive unit 10 is driven by the power supplied from the motor drive unit 40. The drive unit 10 is driven by the power supplied from the motor drive unit 40, and thus the drive unit 10 operates based on the operation command from the controller 50.

The motor drive unit 40 outputs a current value (drive current value Im) that is derived from the power supplied to the drive unit 10, to the controller 50. The controller 50 controls the drive unit 10, using the current value for the current that the motor drive unit 40 provides to the drive unit 10.

[Controller 50]

The controller 50 controls the drive unit 10 such that the gripping force (each of a first gripping force value Fma and a second gripping force value Fmb), detected by the force detector 30, becomes a desired gripping force. The controller 50 also performs a control using the position (position information θm) and the rotation speed (speed information vm) of the rotary shaft that are detected by the encoder 11e, and using a current signal (drive current value Im) from the motor drive unit 40.

The controller 50 is implemented by a micro-processing unit that includes a central processing unit (CPU), a random access memory (RAM), and a read only memory (ROM), for example. The controller 50 performs processing when the CPU loads a program recorded in the ROM into the RAM and then executes the program.

The controller 50 includes an arithmetic processing unit 51, a motor controller 52, a motor-operation data acquiring unit 53, and a force-measurement data acquiring unit 54. The arithmetic processing unit 51 outputs a current control value MVi to the motor controller 52. The motor-operation data acquiring unit 53 outputs, to the arithmetic processing unit 51, a current detection value PVi that is a current value of the drive current that is supplied by the motor drive unit 40 to the power unit 11 (motor 11m), a position detection value PVθ associated with the rotary shaft of the motor 11m, and a speed detection value PVv associated with the rotary shaft. The force-measurement data acquiring unit 54 outputs, to the arithmetic processing unit 51, a gripping-force detection value PVf associated with the gripping force F, which is received from the grip target TGT and is detected by the force detector 30. The force-measurement data acquiring unit 54 also outputs, to the arithmetic processing unit 51, a first gripping force detection value PVfa indicating a first gripping force value Fma and a second gripping force detection value PVfb indicating a second gripping force value Fmb. The details of each component will be described below.

### (Arithmetic Processing Unit 51)

The arithmetic processing unit 51 calculates the operational value for operating the drive unit 10 such that a control value becomes a target value. Specifically, the arithmetic processing unit 51 calculates the current control value MVi such that the gripping-force detection value PVf as the control value becomes a gripping force value used as the target value. The details of the arithmetic processing unit 51 are described below. In the arithmetic processing unit 51 according to the present embodiment, the current control value MVi is output as the operational value, but the operational value of power, a voltage, or the like may be used based on an object to be controlled, instead of using the current.

### (Motor Controller 52)

The motor controller 52 outputs the operational value for operating the power unit 11, specifically the motor 11m, to the motor drive unit 40. In detail, the motor controller 52 performs a conversion to a current control signal Ip that can be input to the motor drive unit 40, based on the current control value MVi output from the arithmetic processing unit 51. Then, the motor controller 52 outputs the current control signal Ip that is obtained in the conversion, to the motor drive unit 40.

The motor controller 52 may output an analog signal as the current control signal Ip, such as a voltage signal or a current signal, as long as the current control signal Ip can be input to the motor drive unit 40. Alternatively, the motor controller 52 may output a digital signal as the current control signal Ip. The motor drive unit 40 provides supplied power Pd to the motor 11m of the power unit 11 based on the current control signal Ip.

### (Motor-Operation Data Acquiring Unit 53)

The motor-operation data acquiring unit 53 acquires motor operation data related to an operational state of the power unit 11, from the power unit 11 and the motor drive unit 40. Specifically, the motor-operation data acquiring unit 53 acquires, from the motor drive unit 40, the drive current value Im that is derived from the supplied power Pd that is provided to the power unit 11 by the motor drive unit 40. The motor-operation data acquiring unit 53 acquires position information Om and speed information vm of the rotary shaft of the motor 11m, from the encoder 11e.

The motor-operation data acquiring unit 53 may acquire the drive current value Im from the motor drive unit 40, for example, by using an analog signal or a digital signal. Similarly, the motor-operation data acquiring unit 53 may acquire, from the encoder 11e, each of the position information Om and the speed information vm, for example, by using the analog signal or the digital signal.

The motor-operation data acquiring unit 53 outputs the current detection value PVi to the arithmetic processing unit 51 based on the acquired drive current value Im. The motor-operation data acquiring unit 53 also outputs a position detection value PVθ to the arithmetic processing unit 51 based on the acquired position information θm. Further, the motor-operation data acquiring unit 53 outputs a speed detection value PVv to the arithmetic processing unit 51 based on the acquired speed information vm.

### (Force-Measurement Data Acquiring Unit 54)

The force-measurement data acquiring unit 54 acquires measurement data of the gripping force F from the force detector 30. Specifically, the force-measurement data acquiring unit 54 acquires a first gripping force value Fma from the first force sensor 31a. The force-measurement data acquiring unit 54 acquires a second gripping force value Fmb from the second force sensor 31b.

The force-measurement data acquiring unit 54 may acquire the first gripping force value Fma from the first force sensor 31a by, for example, an analog signal or a digital signal. Similarly, the force-measurement data acquiring unit 54 may acquire the second gripping force value Fmb from the second force sensor 31b by, for example, an analog signal or a digital signal.

The force-measurement data acquiring unit 54 outputs the gripping-force detection value PVf to the arithmetic processing unit 51 based on the acquired first gripping force value Fma and second gripping force value Fmb. For example, the force-measurement data acquiring unit 54 may output an average gripping force value of the first gripping force value Fma and the second gripping force value Fmb, as the gripping-force detection value PVf.

The force-measurement data acquiring unit 54 outputs a first gripping-force detection value PVfa to the arithmetic processing unit 51 based on the first gripping force value Fma. Similarly, the force-measurement data acquiring unit 54 outputs a second gripping-force detection value PVfb to the arithmetic processing unit 51 based on the second gripping force value Fmb.

### <Detailed Process by Arithmetic Processing Unit 51>

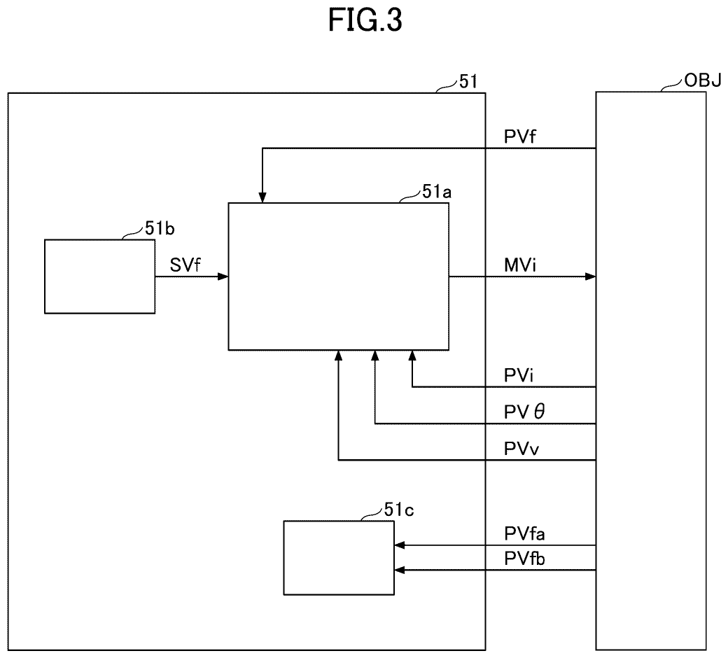

The process by the arithmetic processing unit 51, in other words, steps in a control method executed by the gripping device 1 will be described below in detail. FIG. 3 is a diagram illustrating a functional configuration of the arithmetic processing unit 51 included in the controller 50 of the gripping device 1 according to the present embodiment. In FIG. 3, components provided outside the arithmetic processing unit 51 are collectively shown as objects OBJ to be controlled by the arithmetic processing unit 51. The objects OBJ include, for example, the drive unit 10, the force detector 30, the motor drive unit 40, the motor controller 52, the motor-operation data acquiring unit 53, and the force-measurement data acquiring unit 54.

The arithmetic processing unit 51 determines a force command value SVf for the gripping force F. The arithmetic processing unit 51 also calculates the current control value MVi such that the gripping force detection value PVf becomes the force command value SVf. The arithmetic processing unit 51 uses the current detection value PVi, the position detection value PVθ, and the speed detection value PVV to calculate the current operation value MVi.

The arithmetic processing unit 51 includes an operational value calculator 51a, a force command generator 51b, and a determination unit 51c.

[Operational Value Calculator 51a]

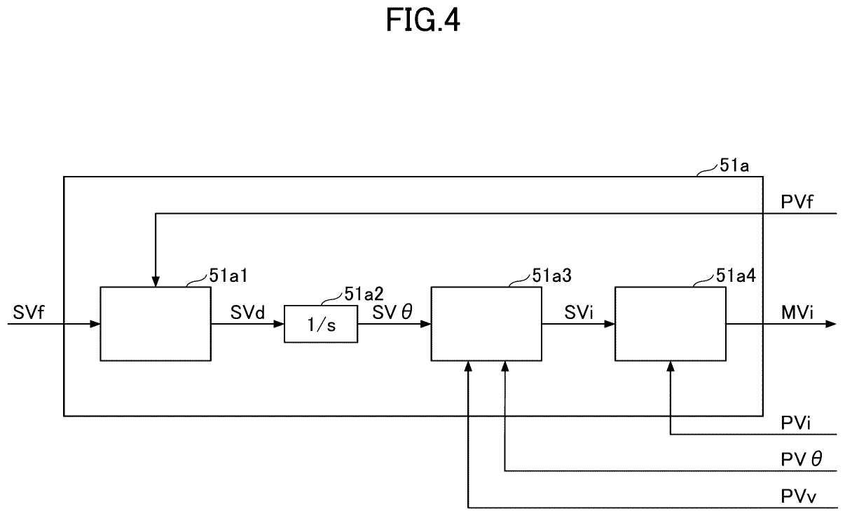

The operational value calculator 51a calculates the current control value MVi such that the gripping-force detection value PVf matches the force command value SVf that the force command generator 51b sets. FIG. 4 is a diagram illustrating a functional configuration of the operational value calculator 51a of the arithmetic processing unit 51 included in the controller 50 of the gripping device 1 according to the present embodiment. In each block of a block diagram, “1/s” expresses the integral.

The operational value calculator 51a includes an admittance processing unit 51a1, an integration operator 51a2, a position-and-speed calculator 51a3, and a current calculator 51a4. Each of these arithmetic components will be described as follows.

### (Admittance Processing Unit 51a1)

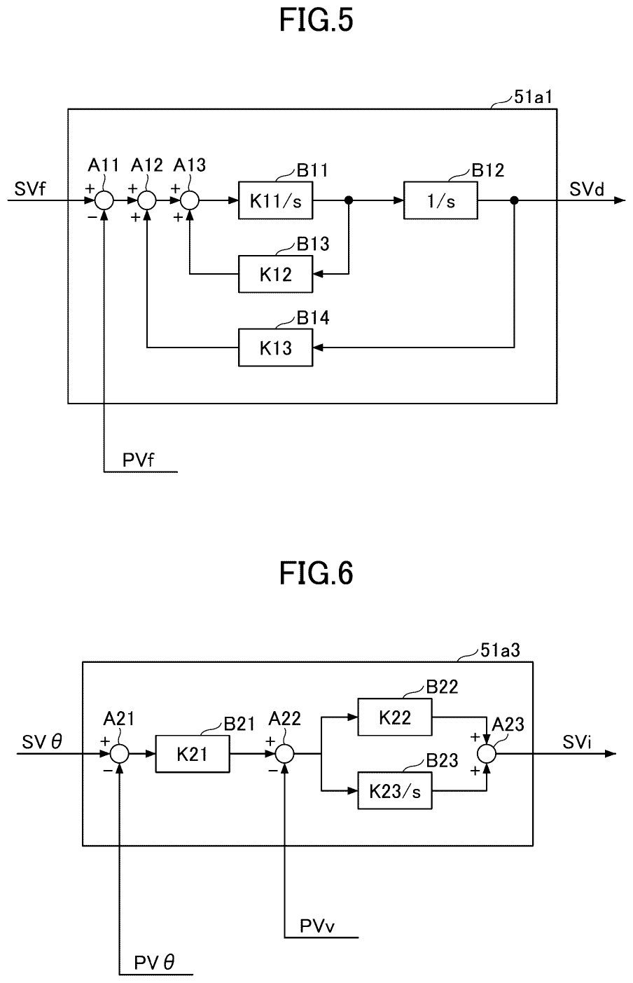

The admittance processing unit 51al converts the force command value SVf to a displacement command value SVd. The admittance processing unit 51a1 calculates (generates) the displacement command value SVd such that the gripping-force detection value PVf matches the force command value SVf. FIG. 5 is a diagram for describing a functional configuration of the admittance processing unit 51a1 of the arithmetic processing unit 51 included in the controller 50 of the gripping device 1 according to the present embodiment.

The admittance processing unit 51al controls parameters in virtual mass-spring-damper systems by solving a differential equation shown in Equation 1.

Here, AF is a difference between the force command value SVf and the gripping-force detection value PVf, M is the weight, C is a damping coefficient for the damper, K is a spring constant for the spring, and x is displacement.

$$\begin{matrix}[ Equation 1 ] & \\ Δ F = M \frac{{d}^{2} x}{{dt}^{2}} + C \frac{dx}{dt} + Kx & EQUATION ( 1 )\end{matrix}$$

The admittance processing unit 51a1 includes an addition-and-subtraction block A11, an addition-and-subtraction block A12, an addition-and-subtraction block A13, an integration block B11, an integration block B12, a gain block B13, and a gain block B14.

Each addition-and-subtraction block outputs a result that is obtained by performing an addition and a subtraction with respect to inputs. Each integration block outputs a result that is obtained performing integration with respect to an input. Each gain block outputs a result that is obtained by multiplying gain by an input. The same approach as described above applies to the process below.

The addition-and-subtraction block A11 calculates a difference between the force command value SVf and the gripping-force detection value PVf. The addition-and-subtraction block A11 outputs a calculation result to the addition-and-subtraction block A12. The addition-and-subtraction block A12 adds an output of the addition-and-subtraction block A11 and an output of the gain block B14. The addition-and-subtraction block A12 outputs a calculation result to the addition-and-subtraction block A13. The addition-and-subtraction block A13 adds an output of the addition-and-subtraction block A12 and an output of the gain block B13. The addition-and-subtraction block A13 outputs a calculation result to the integration block B11.

The integration block B11 integrates an output from the addition-and-subtraction block A13, and multiplies an integration result by gain K11. The integration block B11 outputs a calculation result to the integration block B12 and the gain block B13.

The integration block B12 integrates an output from the integration block B11 and outputs a result. The integration block B12 outputs a displacement command value SVd that is a calculation result, as an output of the admittance processing unit 51a1. The integration block B12 outputs the result of calculation to the gain block B14.

The gain block B13 multiplies the output of the integration block B11 by gain K12 and outputs a result to the addition-and-subtraction block A13. The gain block B14 multiplies the output of the integration block B12 by gain K13 and outputs a result to the addition-and-subtraction block A12.

The gain K11 corresponds to the mass M in Equation 1. The gain K12 corresponds to the attenuation coefficient C in Equation 1. The gain K13 corresponds to the spring constant K in Equation 1.

An admittance control by the admittance processing unit 51al described above is an example of a process. In addition to the control described above, for example, a force control may be performed to use only the spring constant K to calculate the displacement command value SVd based on the gripping force detection value PVf.

The admittance processing unit 51al is an example of a force control calculator that converts the force command value SVf to the displacement command value SVd. A method of converting the command value SVf to the displacement command value SVd is not limited to a method executed by the admittance processing unit 51a1, and various approaches can be adopted.

### (Integration Operator 51a2)

The integration operator 51a2 integrates the displacement command value SVd that is output from the admittance processing unit 51a1, and changes the displacement command value to a position command value Svθ. With use of the admittance processing unit 51al and the integration operator 51a2, positions of the first finger 21a and the second finger 21b are adjusted such that the gripping-force detection value PVf matches the force command value SVf.

### (Position-and-Speed Calculator 51a3)

The position-and-speed calculator 51a3 calculates a current command value SVi such that the first finger 21a and the second finger 21b are disposed at positions that are identified by a position command value SVθ that is output from the integration operator 51a2, and then the position-and-speed calculator 51a3 outputs the current command value SVi. The position-and-speed calculator 51a3 calculates (generates) the current command value SVi such that the position detection value PVθ matches the position command value SVθ. Specifically, the position-and-speed calculator 51a3 performs P (proportional) control for the position, and performs PI (proportional-integral) control for the speed. FIG. 6 is a diagram for describing a functional configuration of the position-and-speed calculator 51a3 of the arithmetic processing unit 51 included in the controller 50 of the gripping device 1 according to the present embodiment.

The position-and-speed calculator 51a3 includes an addition-and-subtraction block A21, an addition-and-subtraction block A22, an addition-and-subtraction block A23, a gain block B21, a gain block B22, and an integration block B23.

The addition-and-subtraction block A21 calculates a difference between the position command value SVθ and the position detection value PVθ. The addition-and-subtraction block A21 outputs a calculation result to the gain block B21. The gain block B21 multiplies the output of the addition-and-subtraction block A21 by gain K21, and outputs a result to the addition-and-subtraction block A22. The addition-and-subtraction block A22 calculates a difference between the output of the gain block B21 and the speed detection value PVv. The addition-and-subtraction block A22 outputs a calculation result to the gain block B22 and the integration block B23.

The gain block B22 multiplies an output of the addition-and-subtraction block A22 by gain K22, and outputs a result to the addition-and-subtraction block A23. The integration block B23 integrates an output from the addition-and-subtraction block A22, and multiplies an integration result by gain K23. The integration block B23 outputs a calculation result to the addition-and-subtraction block A23.

The addition-and-subtraction block A23 calculates a sum of the output of the gain block B22 and the output of the integration block B23. The addition-and-subtraction block A23 outputs the current command value SVi as an output of the position-and-speed calculator 51a3. The gain such as the gain K21 is appropriately determined in consideration of a system response or the like.

### (Current Calculator 51a4)

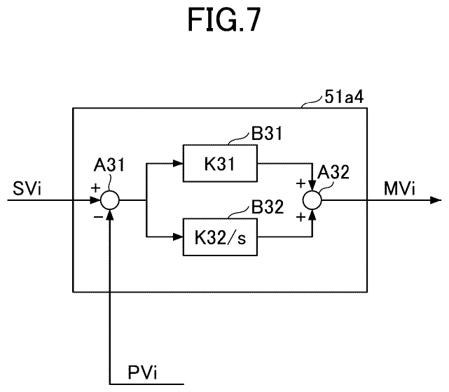

The current calculator 51a4 converts the current command value SVi output from the position-and-speed calculator 51a3, to the current control value MVi. The current calculator 51a4 calculates (generates) the current control value MVi such that the current detection value PVi matches the current command value SVi. Specifically, the current calculator 51a4 performs PI control for the current. FIG. 7 is a diagram for describing a functional configuration of the current calculator 51a4 of the arithmetic processing unit 51 included in the controller 50 of the gripping device 1 according to the present embodiment.

The current calculator 51a4 includes an addition-and-subtraction block A31, an addition-and-subtraction block A32, a gain block B31, and an integration block B32.

The addition-and-subtraction block A31 calculates a difference between the current command value SVi and the current detection value PVi. The addition-and-subtraction block A31 outputs a calculation result to the gain block B31 and the integration block B32.

The gain block B31 multiplies an output of the addition-and-subtraction block A31 by gain K31 and outputs a result to the addition-and-subtraction block A32. The integration block B32 integrates the output from the addition-and-subtraction block A31 and multiplies an integration result by gain K32. The integration block B32 outputs a calculation result to the addition-and-subtraction block A32.

The addition-and-subtraction block A32 calculates a sum of the output of the gain block B31 and the output of the integration block B32. The addition-and-subtraction block A32 outputs the current operation value MVi as the output of the current calculator 51a4. The gain such as the gain K31 is appropriately determined in consideration of a system response or the like.

[Force Command Generator 51b]

The force command generator 51b generates the force command value SVf. The force command generator 51b outputs the force command value SVf corresponding to expected hardness of the grip target.

[Determination Unit 51c]

The determination unit 51c detects a positional deviation of the grip object TGT (deviation of the grip target TGT). The gripping device 1 grips the grip target TGT, assuming that the grip target TGT is arranged at a predetermined position (reference position). The reference position of the gripping device 1 is, for example, a position of the grip target TGT at which a center position of a portion of the grip target TGT gripped by the gripping device 1 matches the center position Ac of the gripping device 1 that grips the grip target TGT. The portion of the grip target TGT gripped by the gripping device 1 refers to a portion of the grip target TGT that is gripped by the first finger 21a and the second finger 21b of the gripping device 1.

The positional deviation of the grip target TGT means that the position of the grip target TGT is offset with respect to the reference position of the gripping device 1. The positional deviation of the grip target TGT refers to, for example, a difference in the gripping direction between the center position of the portion of the grip target TGT gripped by the gripping device 1 and the center position Ac of the gripping device 1 that grips the grip target TGT.

A positional deviation amount of the grip target TGT corresponds to, for example, an amount of misalignment of the center position of the portion of the grip target TGT gripped by the gripping device 1, relative to the center position Ac of the gripping device 1 that grips the grip target TGT. The positional deviation amount of the grip target TGT is not limited to the amount of misalignment of the center position of the portion of the grip target TGT gripped by the gripping device 1, relative to the center position Ac of the gripping device 1 that grips the grip target TGT.

For example, a specific part of the grip target TGT is used as a determination target. When the gripping device 1 grips the grip target TGT, a position of the determination target assumed by the gripping device 1 is used as a prescribed position. When the gripping device 1 grips the grip target TGT, the amount of deviation of an actual position of the determination target in the grip target TGT, relative to the prescribed position, may be used as the positional deviation amount of the grip target TGT.

More specifically, for example, a positive Y-side end of the grip target TGT gripped by the gripping device 1 in the Y-axis direction may be used as the determination target. In this case, when the gripping device 1 grips the grip target TGT, a position of the positive Y-side end of the grip target TGT in the Y-axis direction assumed by the gripping device 1 is set as the prescribed position. Then, when the gripping device 1 grips the grip target TGT, the amount of deviation of the actual position of the determination target that is the positive Y-side end of the grip target TGT in the Y-axis direction, relative to the prescribed position assumed by the gripping device 1, may be set as the positional deviation amount of the grip target TGT.

The determination target is not limited to the positive Y-side end of the grip target TGT in the Y-axis direction. For the determination target, any part of the portion of the grip target TGT gripped by the gripping device 1 may be appropriately selected as the determination target.

A case where the above amount of misalignment of the center position of the portion of the grip target TGT gripped by the gripping device 1, relative to the center position Ac of the gripping device 1 that grips the grip target TGT, is used as the deviation amount of the grip target TGT will be described as follows. When the amount of misalignment of the center position of the portion of the grip target TGT gripped by the gripping device 1, relative to the center position Ac of the gripping device 1 that grips the grip target TGT, is used as the deviation amount of the grip target TGT, the determination target is a central portion of the grip target TGT, and the prescribed position is the center position Ac of the gripping device 1.

The determination unit 51c receives, from the force-measurement data acquiring unit 54, the first gripping-force detection value PVfa indicating the first gripping force value Fma, and the second gripping-force detection value PVfb indicating the second gripping force value Fmb. The determination unit 51c detects the positional deviation of the grip target TGT based on the first gripping-force detection value PVfa and the second gripping-force detection value PVfb. Specifically, the determination unit 51c detects a deviation amount AP of the center position of the portion of the grip target TGT gripped by the gripping device 1, relative to the center position Ac of a gripping position at which the gripping device 1 grips the grip target TGT.

### <Process by Gripping Device 1>

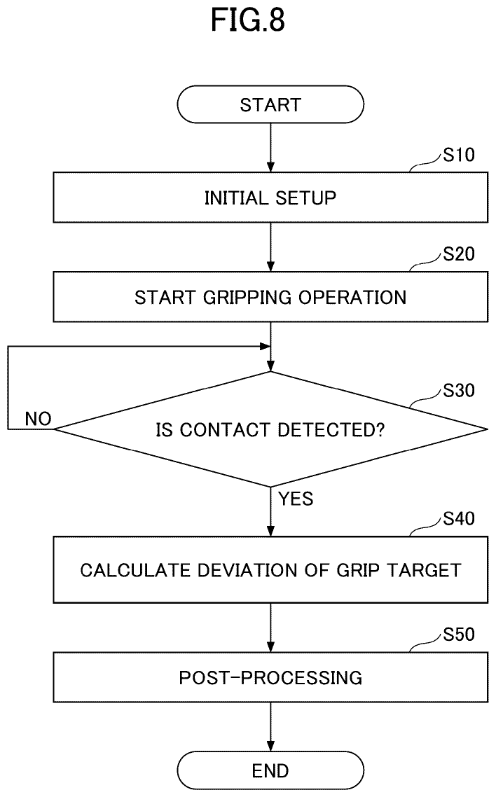

The operation of the gripping device 1 according to the present embodiment will be described as follows. FIG. 8 is a flowchart for describing the process by the arithmetic processing unit 51 in the controller 50 of the gripping device 1 according to the present embodiment.

The gripping device 1 according to the present embodiment is a gripping device with force sensors that include the first force sensor 31a and the second force sensor 31b. A gripping device with force sensors, such as the gripping device 1, performs delicate gripping by detecting changes in a minute force that is applied when the grip target TGT is gripped and by feeding back a detected value to the gripping control. The gripping device 1 according to the present embodiment uses a mechanism of the delicate gripping to thereby detect a deviation of the grip target TGT relative to the gripping device 1. The gripping device 1 further detects a deviation amount of the grip target TGT relative to the gripping device 1.

### (Step S10)

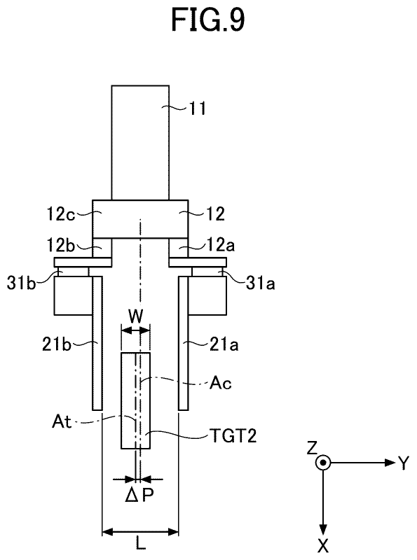

When the process is performed, the arithmetic processing unit 51 performs initial setup. The initial setup includes moving the mechanism unit 60 to a position adjacent to the grip target. FIG. 9 is a diagram for describing the operation of the gripping device 1 according to the present embodiment. Specifically, FIG. 9 shows a state in which the gripping device 1 is moved to a position adjacent to a grip target TGT2 before performing a gripping operation.

A width of the grip target TGT2 is expressed by W. The center position of the grip target TGT2 in the Y-axis direction is expressed by At. The grip target TGT2 is a grip target that extends in a direction parallel in the X-axis direction, and an entirety of the grip target TGT2 is held between the first finger 21a and the second finger 21b in the Y-axis direction. With this arrangement, the center position of the portion of the grip target TGT2 gripped by the gripping device 1 is used as the center position At. The center position of the gripping position at which the gripping device 1 performs gripping is expressed by Ac. A distance between the first finger 21a and the second finger 21b before the gripping device 1 performs gripping, that is, a stroke length is expressed by L.

The grip target is not limited to a grip target in which an entirety of the grip target is held between the first finger 21a and the second finger 21b in the Y-axis direction. For example, a portion of a grip target protrudes, a protruding portion may be held between the first finger 21a and the second finger 21b by using the gripping device 1, and ultimately the grip target may be gripped. Further, for example, a portion of a grip target has a recess or an opening, the first finger 21a and the second finger 21b are inserted in the recess or the opening to increase a distance between the first finger 21a and the second finger 21b, and ultimately the grip target may be gripped.

In FIG. 9, it is assumed that the center position At of the grip target TGT2 in the Y-axis direction deviates from the center position Ac of the gripping position at which the gripping device 1 performs the gripping, by a deviation amount AP that is defined toward the second finger 21b.

### (Step S20)

The arithmetic processing unit 51 starts the gripping operation. Specifically, the arithmetic processing unit 51 moves the first finger 21a and the second finger 21b in a direction in which a distance between these fingers is reduced at a constant speed. The arithmetic processing unit 51 starts a timer at the same timing as that at which the gripping operation starts, and thus the arithmetic processing unit 51 measures the time.

The arithmetic processing unit 51 moves, for example, the first finger 21a and the second finger 21b at a speed v (units: meters per second). In addition, the arithmetic processing unit 51 adjusts the gain or the like so as to perform the gripping by a low gripping force.

The first force sensor 31a and the second force sensor 31b detect forces of components in respective directions in which the first finger 21a and the second finger 21b move.

Before performing step S20, the first finger 21a and the second finger 21b may be in a state in which the largest distance between the fingers is obtained, that is, the distance between the first finger 21a and the second finger 21b corresponds to the stroke length L.

### (Step S30)

Then, the determination unit 51c of the arithmetic processing unit 51 detects whether the first finger 21a or the second finger 21b comes into contact with the grip target TGT2. The determination unit 51c of the arithmetic processing unit 51 detects the contact of the first finger 21a or the second finger 21b with the grip target TGT2 based on the first gripping force value Fma detected by the first force sensor 31a and the second gripping force value Fmb detected by the second force sensor 31b.

For example, if the first gripping-force detection value PVfa corresponding to the first gripping force value Fma is greater than or equal to a predetermined threshold, the determination unit 51c determines that the first finger 21a contacts the grip target TGT2.

That is, for example, if the first gripping-force detection value PVfa corresponding to the first gripping force value Fma is greater than or equal to the predetermined threshold, the determination unit 51c detects that the first finger 21a contacts the grip target TGT2.

Similarly, for example, if the second gripping-force detection value PVfb corresponding to the second gripping force value Fmb is greater than or equal to a predetermined threshold, the determination unit 51c determines that the second finger 21b contacts the grip target TGT2. That is, for example, if the second gripping-force detection value PVfb corresponding to the second gripping force value Fmb is greater than or equal to the predetermined threshold, the determination unit 51c detects that the second finger 21b contacts the grip target TGT2.

If the determination unit 51c detects that the first finger 21a and the second finger 21b contact the grip target TGT2 (YES in step S30), the arithmetic processing unit 51 stops the timer and measures a time period from the start of the operation to a timing at which the grip target is contacted. Then, the arithmetic processing unit 51 proceeds to step S40. If the determination unit 51c does not detect the contact of either the first finger 21a or the second finger 21b with the grip target TGT2 (NO in step S30), the arithmetic processing unit 51 returns to step S30 and repeats the process.

### (Step S40)

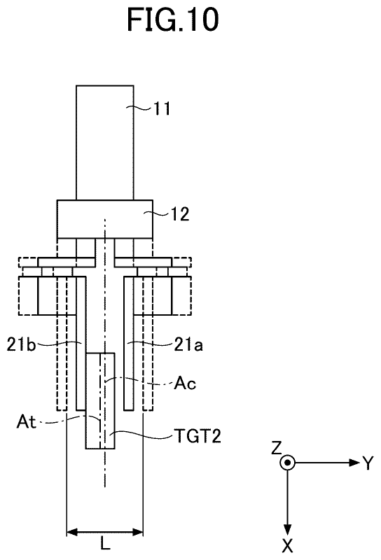

Then, the determination unit 51c of the arithmetic processing unit 51 calculates a deviation amount of the grip target TGT2, that is, the deviation amount AP of the center position At of the grip target TGT2 in the Y-axis direction, relative to the center position Ac of the gripping position at which the gripping device 1 performs gripping. FIG. 10 is a diagram for describing the operation of the gripping device 1 according to the present embodiment. Specifically, FIG. 10 shows a state in which the second finger 21b of the gripping device 1 is in contact with the grip target TGT2. In FIG. 10, dotted lines indicate the first finger 21a and the second finger 21b before performing the gripping operation.

When the grip target TGT2 is to be gripped using the gripping device 1, the first finger 21a and the second finger 21b are closed from respective positions at the same speed v. With this arrangement, unless the center position At of the grip target TGT2 in the Y-axis direction exactly matches the center position Ac of the gripping position at which the gripping device 1 performs the gripping, any one of the first finger 21a and the second finger 21b contacts the grip target TGT2 first.

In FIG. 10, the grip target TGT is shifted toward the second finger 21b. In this case, when the gripping device 1 performs the gripping operation, the second finger 21b contacts the grip target TGT2 before the first finger 21a is contacted.

The gripping device 1 includes a force sensor in each of the first finger 21a and the second finger 21b. That is, the gripping device 1 includes the first force sensor 31a in the first finger 21a, and includes the second force sensor 31b in the second finger 21b.

In the gripping device 1, the first force sensor 31a detects a force that is applied by the contact between the first finger 21a and the grip target TGT2. By detecting the force applied by the contact between the first finger 21a and the grip target TGT2, the first force sensor 31a can accurately measure a time until the first finger 21a comes into contact with the grip target TGT2.

Similarly, in the gripping device 1, the second force sensor 31b detects a force that is applied by the contact between the second finger 21b and the grip target TGT2. By detecting the force applied by the contact between the second finger 21b and the grip target TGT2, the second force sensor 31b can accurately measure a time period until the second finger 21b comes into contact with the grip target TGT2.

Respective moving speeds of the first finger 21a and the second finger 21b are known as speeds v. Before performing the gripping operation, a distance between the first finger 21a and the second finger 21b is a known stroke length L. When a time period t from the start of the gripping operation by the gripping device 1 to a timing at which any one of the first finger 21a and the second finger 21b comes into contact with the grip target TGT2 is identified, a travel distance for any one of the first finger 21a or the second finger 21b to come into contact with the grip target TGT2 can be detected. For example, a travel distance for any one of the first finger 21a and the second finger 21b to come into contact with the grip target TGT2 can be detected in units of millimeters.

It is assumed that the width W of the grip target TGT2 is known. The deviation amount AP of the center position Ac of the gripping position at which the gripping device 1 performs the gripping, relative to the center position At of the grip target TGT2, can be calculated based on a travel distance d for the first finger 21a or the second finger 21b to come into contact with the grip target TGT2 after the gripping device 1 starts the gripping operation; and on the width W of the grip target TGT. Specifically, by use of Equation 2, the deviation amount ΔP can be calculated based on the travel distance d, the width W, the stroke length L or the speed v, the time period t related to the contact, the width W, and the stroke length L.

$$\begin{matrix}[ Math . 2 ] & \\ Δ P = \frac{L}{2} - d - \frac{W}{2} = \frac{L}{2} - v t - \frac{W}{2} & EQUATION ( 2 )\end{matrix}$$

For example, the deviation amount ΔP, the stroke length L, the width W, and the travel distance d are expressed in units of millimeters, the speed v is expressed in units of millimeters per second, and the time period t related with the contact is expressed in units of seconds.

For example, the deviation amount ΔP is calculated based on a time period from the start of the gripping operation to a timing at which any one of the first finger 21a and the second finger 21b comes into contact with the grip target TGT2. When the deviation amount ΔP is greater than a predetermined threshold, the deviation is detected by assuming that there is misalignment of the center position of the grip target relative to the center position of the gripping position at which the gripping device 1 performs the gripping. That is, the gripping device 1 detects the deviation of the grip target TGT2 based on the time period from the start of the gripping operation to the timing at which any one of the first finger 21a and the second finger 21b comes into contact with the grip target TGT2.

As described above, in the gripping device 1 according to the present embodiment, the deviation of the center position of the grip target, relative to the center position of the gripping position at which the gripping device performs the gripping, that is, a deviation of the grip target can be detected, and further, a deviation amount can be detected. In other words, in the gripping device 1 according to the present embodiment, the deviation from a predetermined reference position of the grip target can be detected, and further, the deviation amount of the grip target relative to the reference position can be detected.

### (Step S50)

Then, the arithmetic processing unit 51 performs post-processing based on the deviation amount ΔP calculated by the determination unit 51c. For example, if the deviation amount ΔP calculated by the determination unit 51c is less than the predetermined reference value, the gripping operation may be continuously performed to grip the grip target TGT2. If the deviation amount ΔP calculated by the determination unit 51c is greater than the predetermined reference value, the gripping operation may be stopped.

### Actions and Effects

In the gripping device 1 according to the present embodiment, the deviation of the center position of the grip target, relative to the center position of the gripping position at which the gripping device performs the gripping, can be detected. In addition, in the gripping device 1 according to the present embodiment, the deviation amount of the center position of the grip target, relative to the center position of the gripping position at which the gripping device performs the gripping, can be detected. In other words, in the gripping device 1 according to the present embodiment, the deviation from a predetermined reference position of the grip target can be detected, and the deviation amount of the grip target relative to the reference position can be detected. Further, in the gripping device 1 according to the present embodiment, by calculating the deviation amount ΔP, a device to which the gripping device 1 is attached, such as a multi-joint robot, performs teaching more efficiently, and as a result, work effort can be reduced.

Further, in the gripping device 1 according to the present embodiment, by performing the control based on a calculated deviation amount ΔP, deformation and damage to the grip target, a member for holding the grip target, the gripping device 1, and a device or the like to which the gripping device 1 is attached can be prevented.

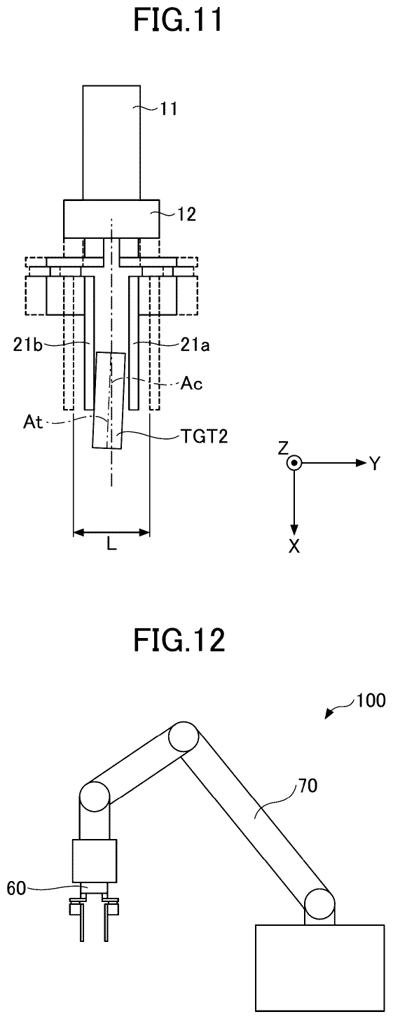

FIG. 11 is a diagram for describing the operation of the gripping device in a reference example. Specifically, FIG. 11 shows a state in which the gripping operation is continuously performed after the second finger 21b of the gripping device 1 contacts the grip target TGT2. In FIG. 11, dotted lines indicate the first finger 21a and the second finger 21b before performing the gripping operation.

For example, when the deviation of the center position At of the grip target TGT2 in the Y-axis direction, relative to the center position Ac of the gripping position at which the gripping device 1 performs the gripping, is increased, in a case where the gripping operation is continuously performed, a greater force is applied to the grip target TGT2 and the second finger 21b in contact with the grip target TGT2.

If the grip target TGT2 is fixed in place by a jig or the like, the grip target TGT2 may be deformed or broken due to a force that is applied from the second finger 21b in contact with the grip target TGT2 to the grip target TGT2. If the grip target TGT2 is fixed in place by a jig or the like, the jig may be deformed or broken due to a force that is applied from the second finger 21b in contact with the grip target TGT2 to the jig.

If the grip target TGT2 is fixed in place by a jig or the like, the second finger 21b may be deformed or broken due to a force that is applied from the grip target TGT2 to the second finger 21b in contact with the grip target TGT2. Further, if the force is applied from the grip target TGT2 to the second finger 21b in contact with the grip target TGT2, a device such as a robot hand to which the mechanism unit 60 is attached may be deformed or broken.

In the gripping device 1 according to the present embodiment, for example, when the deviation amount ΔP is greater than or equal to a certain value, in a case where the gripping operation is stopped, a grip target, a member for holding the grip target, the gripping device 1, and a device or the like to which the gripping device 1 is attached can be prevented from being deformed or broken.

### <<Holding System>>

### <Holding System 100>

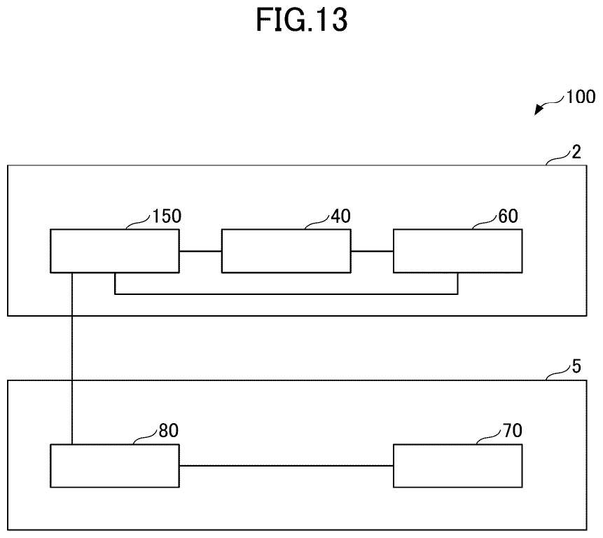

Hereinafter, a gripping system 100 using the gripping device according to the present embodiment will be described. FIG. 12 is a diagram showing a configuration example of the gripping system 100 using the gripping device according to the present embodiment. FIG. 13 is a diagram for describing a functional configuration of the gripping system 100 using the gripping device according to the present embodiment.

The gripping system 100 includes a gripping device 2 and a robot 5.

The gripping device 2 includes a controller 150 instead of the controller 50 of the gripping device 1. The controller 150 includes all functions of the controller 50. The controller 150 transmits a control signal to the robot 5.

The robot 5 includes a robot hand 70 and a robot controller 80. The robot hand 70 includes, for example, a hand of a multi-joint robot. The mechanism unit 60 of the gripping device 2 is attached to a tip of the robot hand 70. The robot hand 70 moves the mechanism unit 60 triaxially and rotates the mechanism unit 60 triaxially.

### <Process by the Gripping System 100>

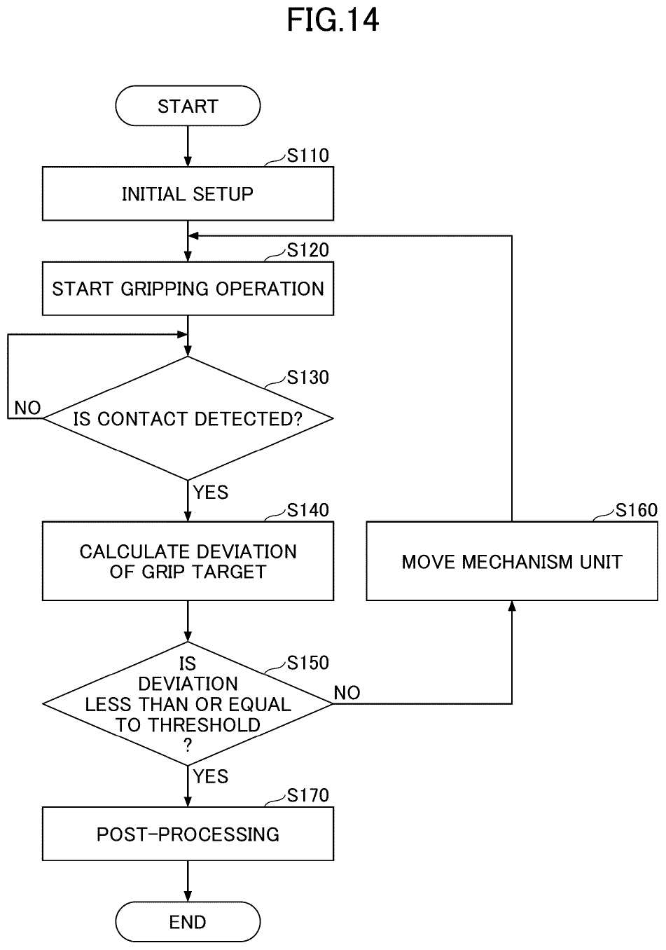

The operation of the gripping system 100 using the gripping device according to the present embodiment will be described below. FIG. 14 is a flowchart for describing the process by the gripping system 100 using the gripping device according to the present embodiment. It is assumed that a width of a grip target is known.

As in the gripping device 1, the gripping device 2 is a gripping device with force sensors that include the first force sensor 31a and the second force sensor 31b. The gripping device 2, which is the gripping device with the force sensors, performs delicate gripping by detecting changes in a minute force that is applied when the grip target TGT is gripped and by feeding back a detected value to a gripping control. The gripping system 100 uses a mechanism of the delicate gripping to thereby perform an appropriate process even if there is a deviation of the grip target TGT relative to the gripping device 2.

### (Step S110)

The gripping system 100 performs initial setup. The robot controller 80 of the gripping system 100 moves the mechanism unit 60 to a position adjacent to a grip target. When the process is started, the arithmetic processing unit 151 performs initial setup. The controller 150 performs the same process as described in step S10 performed by the controller 50.

### (Step S120)

The arithmetic processing unit 151 starts the gripping operation of the gripping device 2. Specifically, the arithmetic processing unit 151 moves the first finger 21a and the second finger 21b in a direction in which a distance between the fingers is reduced at a constant speed. The arithmetic processing unit 151 starts a timer at the same timing as that at which the gripping operation starts, and thus the arithmetic processing unit 151 measures the time.

The arithmetic processing unit 151 moves, for example, the first finger 21a and the second finger 21b at a speed v (in units: meters per second). In addition, the arithmetic processing unit 151 adjusts the gain or the like so as to perform the gripping with a low gripping force.

The first force sensor 31a and the second force sensor 31b detect forces of components in respective directions in which the first finger 21a and the second finger 21b move.

Before performing step S120, the first finger 21a and the second finger 21b may be in a state in which the largest distance between the fingers is obtained, that is, the distance between the first finger 21a and the second finger 21b corresponds to the stroke length L.

### (Step S130)

Then, the determination unit 51c of the arithmetic processing unit 151 detects whether the first finger 21a or the second finger 21b comes into contact with the grip target. The determination unit 51c of the arithmetic processing unit 151 performs the same process as described in the determination unit 51c of the arithmetic processing unit 51 of the gripping device 1.

If the determination unit 51c detects that the first finger 21a and the second finger 21b contact the grip target (YES in step S130), the arithmetic processing unit 151 stops the timer and measures a time period from the start of the operation to a timing at which the contact is detected. Then, the arithmetic processing unit 151 proceeds to step S140. If the determination unit 51c detects the contact, the movement of the first finger 21a and the second finger 21b may be stopped. If the determination unit 51c does not detect the contact of either the first finger 21a or the second finger 21b with the grip target (NO in step S130), the arithmetic processing unit 151 returns to step S130 and repeats the process.

### (Step S140)

Then, the determination unit 51c of the arithmetic processing unit 151 calculates a deviation amount of the grip target, that is, the deviation amount of the center position of the grip target in the Y-axis direction, relative to the center position of the gripping position at which the gripping device 2 performs the gripping. The determination unit 51c of the arithmetic processing unit 151 calculates the deviation amount of the grip target in the same manner as described in the determination unit 51c of the gripping device 1.

### (Step S150)

Then, the arithmetic processing unit 151 determines whether the deviation amount of the grip target is less than or equal to a predetermined threshold. The predetermined threshold is defined by, for example, a deviation amount to the extent to which a grip target, a jig for holding the grip target, and a gripping device are not damaged even if the gripping device 2 grips the grip target.

If the deviation amount of the grip target is less than or equal to the predetermined threshold (YES in step S150), the arithmetic processing unit 151 proceeds to step S170. If the deviation amount of the grip target is greater than the predetermined threshold (NO in step S150), the arithmetic processing unit 151 proceeds to step S160.

### (Step S160)

The robot hand 70 moves the mechanism unit 60 in accordance with the deviation amount calculated in step S140. Specifically, the arithmetic processing unit 151 outputs a calculated deviation amount to the robot controller 80. Based on an input deviation amount, the robot controller 80 reduces a deviation amount related with the mechanism unit 60 and moves the mechanism unit 60 such that the center position of the portion of the grip target gripped by the gripping device 1 matches the center position of the gripping position at which the gripping device 2 performs the gripping. That is, the position of the gripping device 2 can be corrected to a position where the center position of the portion of the grip target gripped by the gripping device 1 matches the center position of the gripping position at which the gripping device 2 performs the gripping. Then, the process returns to step 120 and the process is repeated.

### (Step S170)

If the deviation amount of the grip target is less than or equal to the predetermined threshold (YES in Step S150), the arithmetic processing unit 151 performs post-processing. In this case, a small deviation amount of the center position of the grip target relative to the center position of the gripping position at which the gripping device 2 performs the gripping is obtained, and thus the gripping operation may be continuously performed to grip the grip target.

### Actions and Effects

In the gripping system 100 using the gripping device according to the present embodiment, in addition to providing the above actions and effects by the gripping device, the position of the gripping device can be corrected to a position where the center position of the grip target matches the center position of the gripping position at which the gripping device performs the gripping.

### <Process by Gripping System 100 in Modification>

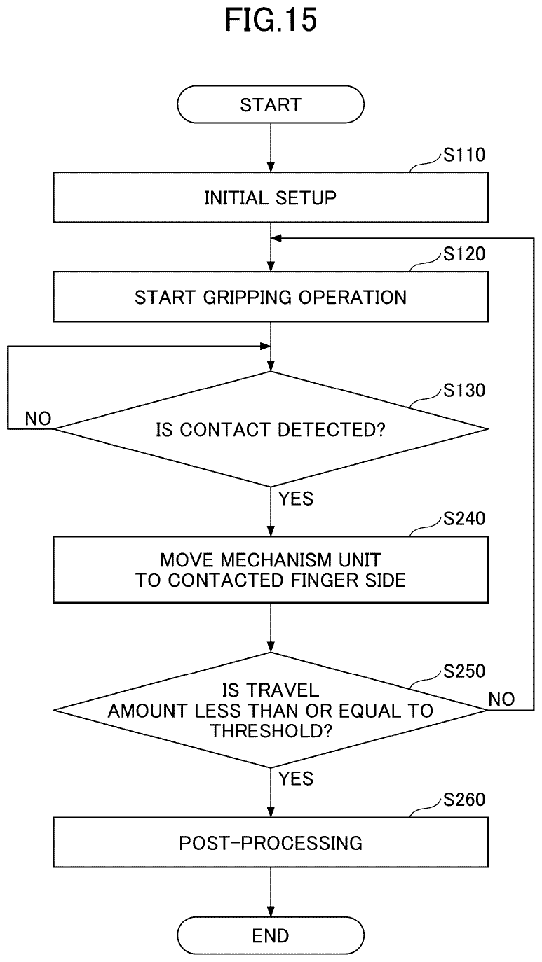

In the process by the gripping system 100 in a modification, a case where a width of the grip target is unknown will be described as follows. FIG. 15 is a flowchart for describing the modified process by the gripping system 100 using the gripping device in the modification to the present embodiment.

Steps S110, S120, and S130 are the same steps as described above, and description thereof is omitted. In step S130, if the determination unit 51c detects the contact of either the first finger 21a or the second finger 21b with the grip target (YES in step S130), the arithmetic processing unit 151 proceeds to step S240.

### (Step S240)

Then, the determination unit 51c of the arithmetic processing unit 151 calculates a travel amount that is a predetermined distance by which the mechanism unit 60 is moved to any side where the first finger 21a or the second finger 21b is contacted. The travel amount is determined, for example, by a percentage of the stroke length L. Then, the determination unit 51c reduces the travel amount each time the process is repeated. That is, the travel amount (travel distance) becomes smaller each time the process is repeated. Note that the travel amount is set to a distance to the extent to which any one of the first finger 21a and the second finger 21b is not contacted even in a case where the mechanism unit moves to a corresponding finger side.

The arithmetic processing unit 151 outputs the travel amount to the robot controller 80. The robot controller 80 moves the mechanism unit 60 by the travel amount, such that the mechanism unit 60 is moved to any side where the first finger 21a or the second finger 21b is contacted.

### (Step S250)

Then, the arithmetic processing unit 151 determines whether the travel amount is less than or equal to a predetermined threshold. The predetermined threshold is defined by, for example, the travel amount that corresponds to the deviation amount to the extent to which a grip target, a jig for holding the grip target, and the gripping device are not damaged even if the gripping device 2 grips the grip target.

If the travel amount is less than or equal to a predetermined threshold (YES in step S250), the arithmetic processing unit 151 determines that a small deviation amount of the center position of the portion of the grip target gripped by the gripping device 1, relative to the center position of the gripping position at which the gripping device performs the gripping, is obtained, that is, a smaller deviation is obtained. Then, the arithmetic processing unit 151 proceeds to step S260. If the travel amount is greater than the predetermined threshold (NO in step S150), the arithmetic processing unit 151 returns to step S120, and repeats the process, assuming that the deviation is detected.

### (Step S260)

If the deviation amount of the grip target is less than or equal to the predetermined threshold (YES in step S250), the arithmetic processing unit 151 performs post-processing. In this case, a smaller deviation amount of the center position of the grip target, relative to the center position of the gripping position at which the gripping device 2 performs the gripping is obtained, and thus the gripping operation may be continuously performed to grip the grip target.

### Actions and Effects

In the process by the gripping system 100 using the gripping device in the modification to the present embodiment, in addition to providing the actions and effects by the gripping system 100, the grip target can be gripped appropriately even when the width of the grip target is unknown.

Although the gripping device is described above according to the embodiments, the present invention is not limited to the above-described embodiments.

Various modifications and improvements such as combinations with or substitutions of a portion of all of the other embodiments can be made within the scope of the present invention.

This application claims priority to Japanese Patent Application No. 2022-011148, filed on Jan. 27, 2022, the entire contents of which are incorporated herein by reference.

### REFERENCE SIGNS LIST

1, 2 gripping device
5 robot
100 grip system
10 drive unit
11 power unit
20 grasper
21a first finger
21b second finger
30 force detector
31a first force sensor
31b second force sensor
40 motor drive unit
50 controller
51 arithmetic processing unit
51a operational value calculator
51a1 admittance processing unit
51a2 integral operator
51a3 position-and-speed calculator
51a4 current calculator
51b force command generator
51c determination unit
60 mechanism unit
70 robot hand
80 robot controller
PVf gripping-force detection value
PVi current detection value
PVV speed detection value
PVθ position detection value
SVf force command value
SVi current command value
SVθ position command value
TGT, TGT2 grip target

1. A gripping device comprising:
a motor configured to rotate according to an operation value;
a grasper including a first finger and a second finger, and configured to change a distance between the first finger and the second finger by using the motor, and to grip an object with the first finger and the second finger;
a force detector configured to detect a gripping force by which the object is gripped with the first finger and the second finger, upon occurrence of a condition in which the object is gripped with the first finger and the second finger; and
a controller configured to output the operation value such that a force detection value of the gripping force detected by the force detector matches a force command value,
wherein the controller is configured to detect a deviation of the object from a predetermined reference position based on a time period from a start of a gripping operation from a timing at which any one of the first finger and the second finger contacts the object.

2. The gripping device according to claim 1, wherein the reference position is a position where a center position between the first finger and the second finger matches a center position of a portion of the object that is to be gripped with the first finger and the second finger.

3. The gripping device according to claim 1, wherein the controller is configured to calculate a deviation amount of a position of the object relative to the reference position, based on a distance between the first finger and the second finger that are situated in a case where the gripping operation is started; a width of the object; and the time period.

4. The gripping device according to claim 3, wherein the controller is configured to perform the gripping operation continuously upon occurrence of a condition in which the deviation amount is less than or equal to a threshold.

5. A gripping system comprising:
the gripping device according to claim 1; and
a robot configured to move,
wherein the robot is configured to move to a side where any one of the first finger and the second finger contacts the gripping device, upon occurrence of a condition in which the controller detects the deviation of the object.

6. The gripping system according to claim 5, wherein upon detecting the deviation of the object by the controller, the robot is configured to repeat a process in which the gripping device moves to the side where any one of the first finger and the second finger contacts the gripping device, and
wherein a travel distance of the gripping device is reduced each time the process is repeated.

7. The gripping system according to claim 6, wherein the controller is configured to detect the deviation of the object upon occurrence of a condition in which the travel distance is greater than a threshold.

8. A method for controlling a gripping device including a motor configured to rotate according to an operation value;
a grasper including a first finger and a second finger and configured to change a distance between the first finger and the second finger by using the motor, and to grip an object with the first finger and the second finger; and
a force detector configured to detect a gripping force by which the object is gripped with the first finger and the second finger, upon occurrence of a condition in which the object is gripped with the first finger and the second finger, the method being for outputting the operation value such that a force detection value of the gripping force detected by the force detector matches a force command value, and the method comprising:
detecting a deviation of the object from a predetermined reference position based on a time period from a start of a gripping operation from a timing at which any one of the first finger and the second finger contacts the object.
